(19) United States
(12) Patent Application Publication
(10) Pub. No.: US 2023/0150181 A1
(43) Pub. Date: May 18, 2023

(54) MOLDING WITH STRUCTURED POLYSILOXANE LAYER AND METHOD FOR ITS PREPARATION

(71) Applicant: BASF COATINGS GMBH, Münster (DE)

(72) Inventors: Timm KROEGER, Münster (DE); Juergen HERRMANN, Ludwigshafen (DE); Rainer KLENZ, Ludwigshafen (DE); Maximilian LEHENMEIER, Ludwigshafen (DE); Zhenhua ZHANG, Münster (DE)

(21) Appl. No.: 17/995,565

(22) PCT Filed: Apr. 9, 2021
(86) PCT No.: PCT/EP2021/059252

§ 371 Date: Oct. 5, 2022

(30) Foreign Application Priority Data
Apr. 9, 2020 (WO) 20168922.1

(51) Int. Cl. B29C 48/00; B29C 48/08; B32B 27/12; B32B 27/36; B32B 7/12; B32B 5/02

(52) U.S. Cl. CPC B29C 48/0021; B29C 48/002; B29C 48/08; B32B 27/12; B32B 27/36; B32B 7/12; B32B 5/02; B29K 2067/003

(57) ABSTRACT

Disclosed herein is a method of preparing a molding containing a structured polysiloxane layer as outermost layer, by using a molding composition (M) to prepare a sheet, film or foil (1), engraving a structure into the surface thereof by means of a laser (2), applying a polysiloxane (PS) onto the surface thereof (3), curing the (PS) to obtain a cured (PS) layer (4), adhering at least one fiber containing material onto the cured (PS) layer obtained with at least one adhesive (A1) (5), and removing the obtained stack including the at least one fiber material adhered to the cured (PS) layer via (A1) from the laser-engraved sheet, film or foil to obtain the molding containing the cured and structured (PS) as outermost layer of the molding, the cured (PS) layer having the negative of the laser engraved structure of the sheet, film or foil (6).

The present invention relates to a method of preparing a molding containing a structured polysiloxane layer as outermost layer, said method comprising at least steps (1) to (6), namely using a molding composition (M) to prepare a sheet, film or foil (1), engraving a structure into the surface thereof by means of a laser (2), applying a polysiloxane (PS) onto the surface thereof, thereby at least partially covering the laser-engraved structure (3), curing the (PS) to obtain a cured (PS) layer (4), adhering at least one fiber containing material onto the cured (PS) layer obtained by making use of at least one adhesive (A1) (5), and removing the obtained stack comprising the at least one fiber containing material adhered to the cured (PS) layer via (A1) from the laser-engraved sheet, film or foil to obtain the molding containing the cured and structured (PS) as outermost layer of the molding, the cured (PS) layer having the negative of the laser engraved structure of the sheet, film or foil (6), wherein the molding composition (M) used in step (1) comprises 50 to 95 wt.-% of at least one thermoplastic polyester homopolymer (m1) and 5 to 50 wt.-% of at least one thermoplastic polyester copolymer (m2), and a molding containing a structured polysiloxane (PS) layer as outermost layer obtainable by this method.

### BACKGROUND OF THE INVENTION

Laser engraving is an embossing technique used nowadays to produce structures into surfaces of suitable materials such as plastics and moldings in general.

WO 2007/033968 A2 relates to a process for the production of a negative or positive die for the production of a surface-structured coating, which can be bonded to a sheet-like substrate, and which is formed by application of a liquid plastic material to the surface of the die and subsequent solidification of the plastic material. The surface structure is produced by laser engraving and contains structure elements in the form of elevations or depressions.

WO 2007/033968 A2 aims at providing coatings good water permeability, fastness and abrasion resistance, which in particular meet the high requirements of the automotive industry with regard to fastness and haptic properties for the interior trim. WO 2008/017690 A2 also discloses a process for the production of a die for the production of a surface-structured coating, which can be bonded to a sheet-like substrate, and which is formed by application of a liquid plastic material to the surface of the die and subsequent solidification of the plastic material. The process comprises a provision of a laser-engravable elastomeric layer, which may be part pf a layer composite, thermochemical, photochemical or actinic reinforcement of the laser-engravable elastomeric layer and engraving of a die surface structure corresponding to the surface structure of the coating into the laser-engravable elastomeric layer using a laser. WO 2007/033968 A2 also aims at providing coatings good water permeability, fastness and abrasion resistance, which in particular meet the high requirements of the automotive industry with regard to fastness and haptic properties for the interior trim.

The embossing methods known from the prior art are not always sufficiently capable, however, of transferring embossments, particularly in the micrometer range and/or in the nanometer range, i.e. microstructures and/or nanostructures, particularly not without lowering the accuracy of modeling to an unacceptable degree, in particular when embossing structures are to be transferred into polysiloxane layers of moldings. There is therefore a need for an embossing method which does not have the disadvantages stated above.

### Problem

It has been therefore an object underlying the present invention to provide a method for transferring laser engraved embossed structures to polysiloxane layers of moldings, which allows the transfer of such structures with a sufficient modeling accuracy, so that embossing is not accompanied by loss of any depth of modulation, and which enables in particular a re-usable embossing die for transferring the embossed structures, and/or can be carried out using an embossing die of this kind.

### Solution

This object has been solved by the subject-matter of the claims of the present application as well as by the preferred embodiments thereof disclosed in this specification, i.e. by the subject matter described herein.

A first subject-matter of the present invention is a method of preparing a molding containing a structured polysiloxane layer as outermost layer, said method comprising at least steps (1) to (6), namely
(1) preparing a sheet, film or foil by making use of a molding composition (M), (2) engraving a structure into at least part of the surface of the sheet, film or foil obtained after step (1) by means of at least one laser,
(3) applying at least one polysiloxane (PS) onto the surface of the sheet, film or foil obtained after step (1), wherein the laser-engraved structure of the sheet, film or foil obtained after step (2) is at least partially covered by the at least one polysiloxane (PS),
(4) curing the at least one polysiloxane (PS) applied in step (3) to obtain a cured polysiloxane (PS) layer at least partially covering the laser-engraved structure of the sheet, film or foil,
(5) adhering at least one fiber containing material onto the surface of the cured polysiloxane (PS) layer obtained after step (4) by making use of at least one adhesive (A1), and
(6) removing the obtained stack comprising the at least one fiber containing material adhered to the cured polysiloxane (PS) layer from the sheet, film or foil prepared by making use of the molding composition (M) and having a laser-engraved structure to obtain the molding containing the cured polysiloxane (PS) layer as structured and outermost layer of the molding, the structure of the cured polysiloxane (PS) layer being the negative of the laser-engraved structure of the sheet, film or foil,

characterized in that the molding composition (M) used in step (1) comprises at least (m1) 50 to 95 wt.-% of at least one thermoplastic polyester homopolymer, and (m2) 5 to 50 wt.-% of at least one thermoplastic polyester copolymer,

wherein the sum of all constituents (m1), (m2) and optional further constituent(s) present in the molding composition (M) adds up to 100 wt.-%.

The structure of the cured polysiloxane (PS) layer, which is the outermost layer of the molding prepared by the inventive method, is the negative of the structure engraved by means of a laser into at least part of the surface of the sheet, film or foil obtained after step (2). The structure is, of course, present on the outside surface of the cured polysiloxane (PS) layer. Accordingly, the laser engraved structure of the sheet, film or foil obtained after step (2) is referred to as the positive structure.

A further subject-matter of the present invention is a molding containing a structured polysiloxane (PS) layer as outermost layer obtainable by the inventive method.

A further subject-matter of the present invention is a use of the inventive molding for producing surface structured coatings, which are preferably connectable to flat supports, in particular based on textile material and/or leather.

It has been surprisingly found that the structure of the molding obtained by the inventive method containing the cured polysiloxane (PS) layer as structured and outermost layer of the molding, —said structure of the cured polysiloxane (PS) layer being the negative of the laser-engraved structure of the sheet, film or foil used as patrix, i.e. mother mold, during the inventive method, —can be obtained in a high resolution and with excellent modeling accuracy, in particular when comparing the structure of the cured polysiloxane and the structure of the laser engraved foil with each other (e.g., when comparing the structure depths of the structure of the laser engraved foil with the structure heights of the structure of the cured polysiloxane). In particular an excellent depth of the structure of the molding could be observed. These advantages are in particular due to using the specific molding composition (M) for preparing the sheet, film or foil in combination with using a polysiloxane in step (3).

It has been further surprisingly found that the sheet, film or foil obtained after step (1) by making use of a molding composition (M) can be excellently engraved by means of a laser in order to engrave a structure into at least part of the surface of the sheet, film or foil.

In addition, it has been surprisingly found that the structure of the molding obtained by the inventive method containing the cured polysiloxane (PS) layer as structured and outermost layer of the molding is of much better quality, in particular accuracy and/or density and/or has a higher aspect ratio, which is desired, than a structure obtained by the same method, where, however, not a laser engraving technique is used in step (2), but instead a step of mechanical drilling in order to obtain a structured sheet, film or foil.

Moreover, it has been surprisingly found that the structure of the molding obtained by the inventive method containing the cured polysiloxane (PS) layer as structured and outermost layer of the molding is of much better quality, in particular homogeneity, than a structure obtained by the same method, where, however, the molding composition (M) used does not comprise the at least one thermoplastic polyester copolymer (m2).

In addition, it has been further surprisingly found that the molding product has a higher stability, e.g. towards the occurrence of cracks, due to performing step (5) and adhering at least one fiber containing material onto the surface of the cured polysiloxane (PS) layer obtained after step (4) by making use of at least one adhesive (A1) for protection as crack propagation can be avoided in this manner.

In addition, it has been further surprisingly found that the molding product has excellent appearance properties.

Moreover, it has been further surprisingly found, in particular when the inventive contains an additional step (7), that the molding product obtained can be better handled due to the presence of the metal sheet or plate, is more stable and additionally allows an improved temperature management as e.g. heating in subsequent applications making use of the molding are also possible from below, i.e. from under the metal sheet or plate.

Finally, it has been found that the sheet, film or foil prepared by making use of the molding composition (M) and having a laser-engraved structure, which is removed in step (6), is not only re-usable and therefore multiply utilizable but also can be produced inexpensively and quickly on the large industrial scale.

### DETAILED DESCRIPTION OF THE INVENTION

Inventive Method

The term “comprising” in the sense of the present invention, e.g. in connection with the molding composition (M) and with the method of the invention and its method steps, preferably has the definition of “consisting of”. With regard for example to the molding composition (M) employed in accordance with the invention—in addition to the constituents (m1) and (m2)— it is possible, moreover, for one or more of the other constituents identified below and optionally present in the composition (M) employed in accordance with the invention to be included in that composition. All the constituents may each be present in their preferred embodiments identified below. With regard to the method of the invention, it may have further optional method steps in addition to steps (1) to (6) as identified hereinafter.

The inventive method is a method of preparing a molding containing a structured polysiloxane layer as outermost layer.

The structure of the cured polysiloxane (PS) layer, which is the outermost layer of the molding prepared by the inventive method, is thus the negative of the structure engraved by means of a laser into at least part of the surface of the sheet, film or foil obtained after step (2). Accordingly, the laser engraved structure of the sheet, film or foil obtained after step (2) is referred to as positive structure.

Step (1) and Molding Composition (M)

According to step (1) of the inventive method a sheet, film or foil is prepared by making use of a molding composition (M). The molding composition (M) comprises at least 50 to 95 wt.-% of at least one thermoplastic polyester homopolymer as constituent (m1) and 5 to 50 wt.-% of at least one thermoplastic polyester copolymer as constituent (m2), wherein the sum of all constituents (m1), (m2) and optional further constituent(s) present in the molding composition (M) adds up to 100 wt.-%.

Preferably, step (1) is performed by extruding pellets made from the molding composition (M) into a sheet, film or foil, preferably having an average thickness in the range of from 750 to 1200 μm, in particular of from 800 to 1050 μm.

Preferably, the sheet, film or foil has an average width in the range of from 1300 to 2000 mm, more preferably of from 1500 to 1800 mm, in particular of from 1600 to 1700 mm.

Preferably, the sheet, film or foil is cut before step (2) is performed, more preferably to an average length, which is determined by the same method as the average width, of from 1300 to 2000 mm, more preferably of from 1500 to 1800 mm, in particular of from 1600 to 1700 mm. Preferably, average width and average length are identical.

Preferably, the least one polyester homopolymer (m1) is selected from the group consisting of polybutylene terephthalate (PBT), polyethylene terephthalate (PET), polytetramethylene terephthalate (PTT), and mixtures thereof, preferably is polybutylene terephthalate (PBT). Preferably, the least one polyester homopolymer (m1) is a semicrystalline polyester having a melting point of 222 to 225° C., typically 223° C. The term melting point is referred to hereinafter. Preferably, the least one polyester homopolymer (m1) is the matrix polymer of the molding obtained in the form of a sheet, film or foil by making use of the molding composition (M). Preferred PBT has a viscosity number in the range of from 120 to 200, preferably from 130 to 190, measured in 0.5 wt.-% solution in a phenol/o-dichlorobenzene mixture (weight ratio 1:1) at 25° C. in accordance with ISO 1628 valid in 2019. The PBT preferably has a terminal carboxy group content of up to 100 meq/kg of polyester, preferably up to 40 meq/kg of polyester and in particular up to 30 meq/kg of polyester. Polyester of this type can by way of example be produced by the process of DE-A 44 01 055. Terminal carboxy group content is determined by titration methods (e.g. potentiometry). Particularly preferred PBTs are produced with Ti catalysts. Residual Ti content of these after the polymerization process is preferably less than 250 ppm, more preferably less 200 ppm, particularly less than 150 ppm. Such products are commercially available, e.g. under the name Ultardur® from BASF SE such as Ultradur® B 6550.

Preferably, the at least one polyester copolymer (m2) is a polyester having both aromatic and aliphatic structural units and which thus represents a “semiaromatic polyester”. Preferably, the least one polyester copolymer (m2) is a statistical or block copolymer, more preferably a statistical copolymer. Preferably, the at least one polyester copolymer (m2) is biodegradable. Preferably, the at least one polyester copolymer (m2) has a melting point below 220° C. The term “melting point” is mainly used for semicrystalline polymers, whereas for amorphous polymers, the glass transition temperature T_{g} replaces the melting point. Thus, the term “melting point”, as used herein, defines or denotes the melting point for semicrystalline polymers, and the T_{g} for amorphous polymers. Preferably, the at least one polyester copolymer (m2) has a melting point below 180° C., most preferably below 160° C. The melting point can be determined by differential scanning calorimetry (DSC) at a heating rate of 20° C./min according to ISO 11357-1/-3 valid in 2019.

In principle, any of the polyesters based on aliphatic and aromatic dicarboxylic acids and on aliphatic dihydroxy compounds, known as semi-aromatic polyesters or copolyesters may be preferably used as constituent (m2). According to the invention, the term “semiaromatic polyester” is intended to also include polyester derivatives, such as polyetheresters, polyesteramides, and polyetheresteramides. Among the suitable semiaromatic polyesters are linear chain-extended polyesters as disclosed in WO 92/09654. Preference is given to chain-extended and/or branched semiaromatic polyesters. The latter are disclosed in WO 96/15173-15176, WO 21689-21692, WO 25446, WO 25448 and WO 98/12242, for example. Mixtures of semiaromatic polyesters may also be used. Such products are commercially available, e.g. under the name Ecoflex® from BASF SE such as Ecoflex® F C1200 or under name Eastar® Bio (Novamont).

Particularly preferred semiaromatic polyesters are polyesters prepared from at least one dicarboxylic acid component and at least one diol component.

Preferably, the acid component present in the polyester contains 30 to 90 mole-% structural units prepared from an acid at least one aliphatic or cycloaliphatic dicarboxylic acid or an ester forming derivative thereof and 1 to 70 mole-% of at least one aromatic dicarboxylic acid or an ester forming derivative thereof and optionally 0 to 5 mole-% of a sulfonate group containing compound. Preferably, the diol component present in the polyester is selected from at least one C₂-C₁₂ alkanediol and at least one C₅-C₁₀ cylcoalkanediol or mixtures thereof.

Aliphatic acids and the corresponding derivatives, which may be used are generally those having from 2 to 10 carbon atoms, preferably from 4 to 6 carbon atoms. They may be either linear or branched. The cycloaliphatic dicarboxylic acids which may be used are those having from 7 to 10 carbon atoms. However, it is also possible to use dicarboxylic acids having a larger number of carbon atoms, for example having up to 36 carbon atoms. Examples are malonic acid, succinic acid, glutaric acid, adipic acid, pimelic acid, azelaic acid, sebacic acid, fumaric acid, brassylic acid and maleic acid. It is preferable to use succinic acid, adipic acid, azelaic acid, sebacic acid, brassylic acid, or their respective ester-forming derivatives, or a mixture thereof. Adipic acid is most preferred.

Aromatic dicarboxylic acids are those having from 8 to 12 carbon atoms, for example phthalic acid, terephthalic acid, isophthalic acid, 2,6-naphthoic acid and 1,5-naphthoic acid, and also ester-forming derivatives thereof. Anyhydrides may also be used.

The diols are generally selected from the group consisting of branched or linear alkanediols having from 2 to 12 carbon atoms, preferably from 4 to 6 carbon atoms, or from the group consisting of cycloalkanediols having from 5 to 10 carbon atoms. Examples of suitable alkanediols are ethylene glycol, 1,2-propanediol, 1,3-propanediol, 1,2-butanediol, 1,4-butanediol, 1,5-pentanediol, 2,4-dimethyl-2-ethyl-1,3-hexanediol, 2,2-dimethyl-1,3-propanediol, 2-ethyl-2-butyl-1,3-propanediol, 2-ethyl-2-isobutyl-1,3-propanediol and 2,2,4-trimethyl-1,6-hexanediol, in particular ethylene glycol, 1,3-propanediol, 1,4-butanediol or 2,2-di-methyl-1,3-propanediol (neopentyl glycol); cyclopentanediol, 1,4-cyclohexanediol, 1,2-cyclohexanedimethanol, 1,3-cyclohexanedimethanol, 1.4-cyclohexanedimethanol or 2,2,4,4-tetram ethyl-1, 3-cyclobutanediol. Particular preference is given to 1,4-butandiol.

Most preferably, at least monomers 1,4-butanediol, adipic acid and terephthalic acid are used form preparing the at least one polyester copolymer (m2). Such products are commercially available, e.g. under the name Ecloflex® from BASF SE such as Ecoflex® F C1200.

Preferably, the molding composition (M) used in step (1) comprises
(m1) 65 to 90 wt.-%, preferably 70 to 85 wt.-%, of the at least one polyester homopolymer,
(m2) 10 to 35 wt.-%, preferably 15 to 30 wt.-%, of the at least one polyester copolymer,
(m3) 0 to 40 wt.-% of at least one filler being different from both constituents (m1) and (m2) and
(m4) 0 to 20 wt.-% of at least one further additive being different from both constituents (m1) and (m2) and (m3),

wherein the sum of all constituents (m1), (m2) and optional further constituent(s) (m3) and/or (m4) present in the molding composition (M) adds up to 100 wt.-%.

Preferably, at least constituents (m1) and (m2) of the molding composition (M) are incorporated therein in form of a polymer blend comprising at least constituents (m1) and (m2).

As constituent (m3) mineral fillers are preferred such as basalt, kaolin, wollastonite, talc, silica, alumina and mixtures thereof.

As constituent (m4) additives such as lubricants, antiblocking agents, nucleating agents, plasticizers, surfactants, antistatic agents, dyes and/or anti-fogging agents can be used.

Step (2)

According to step (2) of the inventive method a structure is engraved into at least part of the surface of the sheet, film or foil obtained after step (1) by means of at least one laser.

The laser engraved sheet, film or foil obtained after step (2) serves as patrix, i.e. as mother mold or embossing die for preparing the molding containing a structured polysiloxane layer as outermost layer (on its outside surface). The laser engraved structure of the sheet, film or foil obtained after step (2) is the positive structure, whereas the structure of the polysiloxane layer as outermost layer of the molding obtained by the inventive method is its corresponding negative structure.

Step (2) is preferably performed by cutting the sheet, film or foil obtained after step (1) to a width and length suitable for the laser used in step (2) as the maximum laser capacity of a laser used may be limited by itslaser drum. Preferably, in step (2) the sheet, film or foil is clamped on the laser and fixed on the laser drum. The drum then preferably rotates and the laser beam creates the desired structure into the sheet, film or foil.

After finishing step (2) the resulting laser engraved sheet, film or foil is preferably cleaned.

The laser engraving technique used in step (2) is known to a person skilled in the art. In the direct laser engraving technique, a three-dimensional structure is engraved directly into a material surface. This technique has attracted broader economic interest only in recent years with the appearance of improved laser systems. The improvements in the laser systems include better focusability of the laser beam, higher power and computer-controlled beam guidance. Direct laser engraving has a plurality of advantages over conventional, for example mechanical, structuring processes. For example, three-dimensional motif elements can be individually formed in the laser engraving technique. Certain elements can be produced so as to be different from other elements, for example with regard to depth and steepness. Furthermore, in principle any digital original motif can be engraved into a material surface by means of the laser engraving technique after suitable conversion into a three-dimensional relief image, whereas, in conventional structuring techniques, the three-dimensional shape of an element is limited either by a natural three-dimensional original or the geometry of the imaging tool. Finally, the laser engraving process is highly automatable so that the entire process is not very susceptible to individual errors and is very readily reproducible. In this way, structured materials can be produced in high constant quality.

The engraved structures are based preferably and in each case independently of one another on a repeating and/or regularly arranged pattern. The structure in each case may be a continuous embossed structure such as a continuous groove structure or else a plurality of preferably repeating individual embossed structures. The respective individual embossed structures in this case may in turn be based preferably on a groove structure having more or less strongly pronounced ridges (embossed elevations) defining the embossed height of the embossed structure. In accordance with the respective geometry of the ridges of a preferably repeating individual embossed structure, a plan view may show a multiplicity of preferably repeating individual embossed structures, each of them different, such as, for example, preferably serpentine, sawtooth, hexagonal, diamond-shape, rhomboidal, parallelogrammatical, honeycomb, circular, punctiform, star-shaped, rope-shaped, reticular, polygonal, preferably triangular, tetragonal, more preferably rectangular and square, pentagonal, hexagonal, heptagonal and octagonal, wire-shaped, ellipsoidal, oval and lattice-shape patterns, it also being possible for at least two patterns to be superimposed on one another. The ridges of the individual embossed structures may also have a curvature, i.e., a convex and/or concave structure.

The respective embossed structure may be described by its width such as the width of the ridges, in other words by its structure width, and by the height of the embossments, in other words by its structure height (or structure depth). The structure width such as the width of the ridges may have a length of up to one centimeter, but is preferably situated in a range from 10 nm to 1 mm. The structure height is situated preferably in a range from 0.1 nm to 1 mm. Preferably, however, the respective embossed structure represents a microstructure and/or nanostructure. Microstructures here are structures—in terms both of structure width and of structure height—having characteristics in the micrometer range. Nanostructures here are structures—in terms both of structure width and of structure height—having characteristics in the nanometer range. Microstructures and nanostructures here are structures which have a structure width in the nanometer range and a structure height in the micrometer range or vice-versa.

The structure width of the respective embossed structure is preferably situated in a range from 10 nm to 500 μm, more preferably in a range from 25 nm to 400 μm, very preferably in a range from 50 nm to 250 μm, more particularly in a range from 100 nm to 100 μm. The structure height of the respective embossed structure is situated preferably in a range from 10 nm to 500 μm, more preferably in a range from 25 nm to 400 μm, very preferably in a range from 50 nm to 300 μm, more particularly in a range from 100 nm to 200 μm.

The structure width and structure height of the respective embossed structure are determined here by mechanical scanning of the surface. In this case the embossed height is measured at not less than 10 points on a line, distributed uniformly over the web width of the sample, taking care to ensure that the scanning instrument does not compress the embossed structure. The determination of the structure height represents a determination of the accuracy of modeling and is accomplished by means of scanning force microscopy in accordance with the method described below.

Step (3) and Polysiloxane (PS)

According to step (3) of the inventive method at least one polysiloxane (PS) is applied onto the surface of the sheet, film or foil obtained after step (1), wherein the laser-engraved structure of the sheet, film or foil obtained after step (2) is at least partially, preferably fully, covered by the at least one polysiloxane (PS). The term polysiloxane (PS) preferably includes all siloxanes, which are not monomeric, i.e. also oligosiloxanes. The polysiloxanes (PS) used are also named preferably vulcanizing silicone rubbers.

Preferably, the at least one polysiloxane (PS), preferably at least one polydialkylsiloxane, applied in step (3), preferably in combination with at least one hardener, is applied in liquid form via a casting process. The polysiloxane (PS) applied in step (3) is thus preferably a casted polysiloxane.

Preferably, the laser engraved sheet, film or foil is positioned on an even surface and fixed by an adhesive tape. In a next step a frame such as a frame having a surrounding height of 0.5 to 1.0 mm created by a filament is positioned on top of this fixed sheet, film or foil. The filament is positioned outside the laser engraved area and fixed by an adhesive tape. The polysiloxane is then preferably casted on top of the sheet, film or foil and spread homogeneously, preferably only by viscosity or with additional tools as the polysiloxane used such as a polydialkylsiloxane, in particular polydimethylsiloxane is preferably self-levelling, until the cavity built by the positioned filament is filled.

Suitable polysiloxane products are commercially available, e.g. under the name Elastosil® such as Elastosil® M 4470 or Elastosil® M 4370 or Elastosil® RT 607 A/B from Wacker Chemie. Preferably, a 2K (two-component) product is used containing additionally a hardener component for curing and/or accelerating the curing velocity. Suitable hardeners are also commercially available such as T 40 from Wacker Chemie. Preferably, 0.5 to 5 wt.-%, more preferably 1 to 4 wt.-% of a hardener as used, based on the total weight of the polysiloxane component used. Alternatively, however, also 1K (one-component) products can be used. However, 2K products are preferred.

Polydialkylsiloxanes, in particular polydimethylsiloxanes, are especially preferred. Preferably, the polysiloxanes (PS) used are addition curing and/or condensation curing polysiloxanes. Preferably, vulcanizing polysiloxanes (PS) are used.

Step (4)

According to step (4) of the inventive method the at least one polysiloxane (PS) applied in step (3) is cured to obtain a cured polysiloxane (PS) layer at least partially, preferably fully, covering the laser-engraved structure of the sheet, film or foil.

Step (5) and Adhesive (A1)

According to step (5) of the inventive method at least one fiber containing material is adhered onto the cured polysiloxane (PS) layer obtained after step (4) by making use of at least one adhesive (A1).

The fiber containing material preferably comprises synthetic or natural fibers, more preferably synthetic fiber. Examples are polymer fibers such as polyolefine, polyamide and/or polyester fibers. It is also possible to use glass and/or carbon fibers. The fiber containing material can be a woven or non-woven fabric. Suitable fiber containing material products are commercially available, such as e.g. Parafil® products from the company Linear Composites, Ltd.

Preferably, adhering step (5) is performed by making use of at least one polysiloxane adhesive (A1), which is used to adhere the at least one fiber containing material onto the cured polysiloxane (PS) layer.

The adhesive (A1) is preferably a polysiloxane adhesive, more preferably a 1K polysiloxane adhesive, which is different from polysiloxane (PS). Suitable polysiloxane products are commercially available, e.g. under the name Elastosil® such as Elastosil® E10 from Wacker Chemie.

Using the adhesive (A1) the fiber containing material is adhered on the surface of the preferably casted and cured polysiloxane (PS). For this preferably the adhesive (A1) is casted on the cured polysiloxane (PS) and the fiber containing material is rolled on its surface.

Optional Step (5a)

According to optional step (5a) of the inventive method, which is performed after step (5) and prior to step (6), namely the at least one adhesive (A1) used to adhere the at least one fiber containing material onto the cured polysiloxane (PS) layer is cured.

Step (6)

According to step (6) of the inventive method the obtained stack comprising the at least one fiber material adhered to the cured polysiloxane (PS) layer is removed from the sheet, film or foil prepared by making use of the molding composition (M) and having a laser-engraved structure to obtain the inventive molding containing the cured polysiloxane (PS) layer as structured and outermost layer of the molding, the structure of the cured polysiloxane (PS) layer being the negative of the laser-engraved structure of the sheet, film or foil.

The molding obtain after step (6) of the inventive method has the following sequence of layers and materials: (i) fiber containing material, (ii) cured adhesive (A1) and (iii) cured polysiloxane (PS) layer as structured and outermost layer.

Preferably, the sheet, film or foil prepared by making use of the molding composition (M) and having a laser-engraved structure re-obtained after removing step (6) is re-usable, preferably repeatedly, in steps (3) to (6) of the method.

Optional Step (7) and Adhesive (A2)

According to optional step (7) of the inventive method at least one metal sheet or plate, preferably comprising aluminum or an aluminum alloy, is adhered onto the fiber containing material of the inventive molding containing the cured polysiloxane layer as structured and outermost layer of the molding obtained after step (6) by making use of at least one adhesive (A2), preferably at least one polysiloxane adhesive (A2).

Adhesive (A2) used in step (7) may be identical to or different from the adhesive (A1) used in step (5). Preferably, adhesive (A2), more preferably polysiloxane adhesive (A2), is identical to adhesive (A1), more preferably polysiloxane adhesive (A1). Both polysiloxane adhesives (A1) and (A2) are, however, different from polysiloxane (PS) applied in step (3) of the inventive method. Adhesive (A2) preferably is a 1K polysiloxane adhesive, more preferably the same adhesive as adhesive (A1). Preferably, optional step (7) is carried out in three sub-steps (7a), (7b) and (7c), namely by

(7a) adhering at least one adhesive (A2), preferably at least one polysiloxane adhesive (A2), onto the surface of at least one metal sheet or plate, preferably comprising aluminum or an aluminum alloy, preferably by applying the at least one adhesive (A2) in liquid form via a casting process onto the surface of the at least one metal sheet or plate, followed by

(7b) applying the molding containing the cured polysiloxane layer as structured and outermost layer of the molding obtained after step (6) with its fiber containing material side onto the adhesive (A2) applied onto the surface of the at least one metal sheet or plate in step (7a), followed by

(7c) pressing the stack obtained after step (7b), preferably in a static press, preferably for a period of 5 to 30 minutes such as 15 to 25 minutes, and curing, preferably for 12 to 36 hours, of the at least one adhesive (A2) to obtain a molding having the following sequence of layers and materials: (i) metal sheet or plate, (ii) cured adhesive (A2), (iii) fiber containing material, (iv) cured adhesive (A1) and (v) cured polysiloxane (PS) layer as structured and outermost layer.

Inventive Molding

A further subject-matter of the present invention is a molding containing a structured polysiloxane (PS) layer as outermost layer obtainable by the inventive method.

All preferred embodiments described hereinabove in connection with the method of the invention are also preferred embodiments in relation to the molding of the invention.

Inventive Use

A further subject-matter of the present invention is a use of the inventive molding for producing surface structured coatings, which are preferably connectable to flat supports, in particular based on textile material and/or leather. Examples of textile material include leather, fleece, woven or non-woven fabric. Preferably, the produced surface structured coatings are in turn for use in the automotive industry, in particular for car interior, in the furniture industry, in particular for cushions such as seat cushions, and/or in the fashion sector, in particular for clothing material and/or shoe material.

All preferred embodiments described hereinabove in connection with the method of the invention and the inventive molding are also preferred embodiments in relation to the use of the invention.

### Methods

1. Determining the Nonvolatile Fraction

The nonvolatile fraction (the solid fraction or solid content) is determined according to DIN EN ISO 3251:2018-071. The method involves weighing out 1 g of sample into an aluminum tray that has been dried beforehand and drying the sample in a drying cabinet at 125° C. for 60 minutes, cooling it in a desiccator, and then reweighing it. The residue, relative to the total amount of sample employed, corresponds to the nonvolatile fraction.

2. Determining the Modeling Accuracy

The modeling accuracy is determined by means of a commercial atomic force microscope (AFM) and using a commercial cantilever. By means of AFM it is possible accordingly to compare, for example, the surface topography of a defined structure such as that of the laser-engraved structure of the sheet, film or foil obtained by making of the molding composition (M) with the surface topography of the structure of the cured polysiloxane layer as outermost layer of the molding obtained by the inventive method. In this case the laser-engraved structure of the sheet, film or foil obtained by making of the molding composition (M) is deliberately damaged at a particular site in order to define a reference point. By means of this reference point it is possible to investigate and compare with one another the same regions of the reference and of the replication. The modeling accuracy defines how accurately a particular reference structure (the positive) can be transferred, such as from the laser-engraved structure of the sheet, film or foil obtained by making of the molding composition (M) to the cured polysiloxane layer as outermost layer of the molding obtained by the inventive method (which then contains the negative of the structure). If, for example, the investigated region of the above mentioned laser-engraved structure of the sheet, film or foil features a structure having a depth of 140 nm, then this reference depth is compared with the corresponding height of the structure determined on the cured polysiloxane layer as outermost layer of the molding obtained by the inventive method. The percentage change, corresponding here to the modeling accuracy, is defined as:

$$Δ h = 100 * ( 1 - \frac{{h}_{m}}{{h}_{r}} )$$

Δh corresponds here to the percentage change, hₘ to the height of the structure in the investigated region of the cured polysiloxane layer as outermost layer of the molding obtained by the inventive method, and hᵣ to the corresponding depth of the structure of the investigated region of the above mentioned laser-engraved structure of the sheet, film or foil. This percentage change, in other words the modeling accuracy, is also referred to as ‘contraction’. The smaller the values of Δh, the better the modeling accuracy.

### Examples

The following example further illustrates the invention but is not to be construed as limiting its scope.

1. Exemplary Method According to the Present Invention

A polymer blend of 80 wt.-% of Ultradur® B 6550 (a commercially available PBT homopolymer from BASF SE) and 20 wt.-% of Ecoflex® F C1200 (a commercially available biodegradable polyester copolymer from BASF SE containing both aliphatic and aromatic structural units) was prepared. The blend pellets were then extruded and processed to achieve a foil. The resulting material was then further extruded to achieve a homogeneous average thickness of the foil in the range of from 870 to 930 μm, an average width of 1650 mm and a smooth surface. The resulting product was cut (about 1650 mm average length) to achieve a geometry of about 1650×1650 mm of the foil, this geometry being preferable in view of the maximum laser capacity of the laser used in the next step (limited by the laser drum).

The resulting foil was then clamped on the laser and fixed on the laser drum. The drum rotates and the laser beam creates the desired design structure into the foil (a deep velvet structure). The resulting laser engraved foil is subsequently used as patrix (mother mold). After finishing the laser step the foil is cleaned.

A casting process was next used to apply a polysiloxane onto the laser engraved surface of the foil. The laser engraved foil was positioned on a smooth and even surface and fixed by an adhesive tape. In a next step a 1 mm high frame created by a filament was positioned on top of this fixed laser engraved foil. The filament was positioned outside and around the laser engraved area and fixed by an adhesive tape, thereby fully covering the laser engraved structure of the foil. As polysiloxane a liquid commercially available product was used, namely Elastosil® M 4470 from Wacker, which is a 2K polysiloxane product used in combination with a hardener component (T 40, also from Wacker). The prepared mixture of polysiloxane and hardener component was casted on top of the foil within the filament on the laser engraved surface and spread homogeneously until the cavity built by the positioned filament was filled with the mixture.

The casted polysiloxane is then cured.

After curing the polysiloxane is (still) very sensitive, e.g., regarding crack propagation. Therefore, the polysiloxane layer generated is left on top of the foil until the following stabilization step is completed: For this, a commercially available polysiloxane adhesive (1K adhesive Elastosil® E10 from Wacker) was applied on the cured and casted polysiloxane and then Parafil®, a commercially available fiber containing material from Linear Composites, Ltd. was adhered via said polysiloxane adhesive on the surface of the casted and cured silicone. This was performed by casting Elastosil® E10 on the cured polysiloxane layer and then the Parafil® material was rolled on its surface.

After curing of the Elastosil® E10 adhesive the stack comprising the Parafil® material, the cured Elastosil® E10 adhesive and the cured polysiloxane layer (generated from Elastosil® M 4470 and hardener T 40) in this sequence is removed from the laser engraved foil. Laser engraved foil (mother mold) as well as the filament used for the Elastosil® M 4470 casting were recovered and can be re-used. The aforementioned stack represents an inventive molding and its cured polysiloxane layer is structured, namely has on its surface the negative structure of the laser engraved foil used as mother mold.

The removed stack (comprising the Parafil® material, the cured Elastosil® E10 adhesive and the cured and structured polysiloxane layer) was then adhered onto an aluminum sheet. For this the aluminum sheet was sanded and its surface was cleaned. Elastosil® E10 is then casted on the sanded and cleaned A1 sheet. Then the aforementioned stack is rolled on top of the aluminum sheet, the sheet facing the Parafil® side of the stack with the Elastosil® E10 side of the A1 sheet. The whole resulting build up was then pressed for about 20 minutes in a static press. Afterwards, the adhesive Elastosil® E10 applied for adhering the A1 sheet to the Parafil® side of the stack is cured and a molding having the following sequence of layers and materials was obtained: (i) A1 sheet, (ii) cured Elastosil® E10, (iii) Parafil®, (iv) cured Elastosil® E10 and (v) cured polysiloxane layer (derived from Elastosil® M 4470 and T40), the cured polysiloxane being structured and having on its outside surface the negative structure of the laser engraved foil used as mother mold.

An excellent modeling accuracy was observed when comparing the structures of the cured polysiloxane and the structure of the laser engraved foil with each other (e.g., when comparing the structure depths of the structure of the laser engraved foil with the structure heights of the structure of the cured polysiloxane).

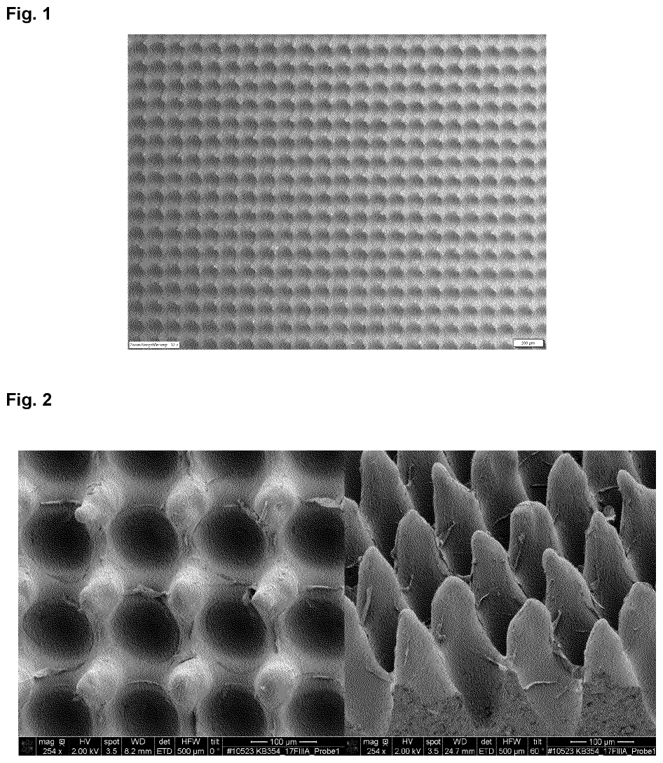

FIG. 1 shows a microscope image of the surface structure of the obtained stack comprising the Parafil® material, the cured Elastosil® E10 adhesive and the cured polysiloxane layer. FIG. 2 shows corresponding SEM images of said surface structure. As it is in particular evident from the SEM images, structures with high density and a high aspect ratio are obtained using the inventive method making use of laser engraving technology.

2. Exemplary Method (Comparative)

The same method as disclosed hereinbefore in item 1. was performed with the only exception that the desired design structure (a deep velvet structure) was not engraved by a laser into the foil. Instead the desired deep velvet structure was obtained by mechanical drilling.

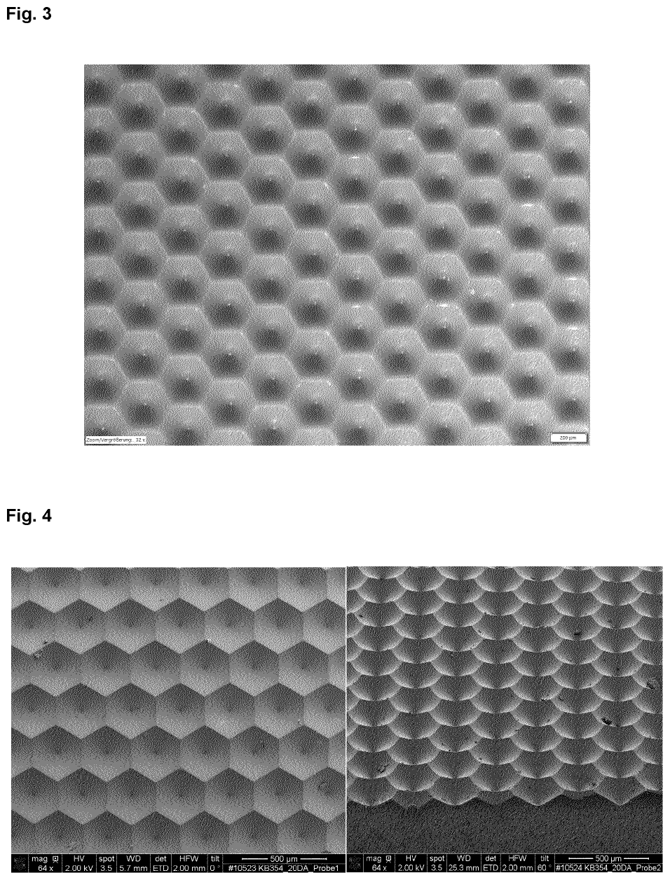

The resulting surface structure of the obtained stack comprising the Parafil® material, the cured Elastosil® E10 adhesive and the cured polysiloxane layer showed significant differences to the surface structure obtained by the method described hereinbefore in item 1. (making use of laser engraving technology). FIG. 3 shows a microscope image of the surface structure of the obtained stack comprising the Parafil® material, the cured Elastosil® E10 adhesive and the cured polysiloxane layer. FIG. 4 shows corresponding SEM images of said surface structure.

As it is evident from comparing in particular the SEM images of FIG. 2 and FIG. 4, a significantly higher density of structures and higher aspect ratio is achieved using laser engraving technology (FIG. 2), that leads e.g. to significant advantages in the haptic feeling of the surface structure, when compared to the surface structure of the obtained stack prepared by a comparative method involving mechanical drilling of the foil for generating the surface structure (FIG. 4).

3. Exemplary Method (Comparative)

The same method as disclosed hereinbefore in item 1. was performed with the only exception that not the described polymer blend of Ultradur® B 6550 and Ecoflex® F C1200 was used to prepare the foil, but instead merely Ultradur® B 6550 alone, i.e. a polyester (PBT) homopolymer. The resulting foil was much stiffer than the foil prepared when additionally using Ecoflex® F C1200, resulting in particular in an undesired curving of the foil.

Laser engraving of this PBT-foil, however, only led to an inhomogeneous surface structure of the resulting laser engraved foil due to its stiffness and curving. Laser engraving of this material even enhanced the observed undesired curving of the foil due to thermal tension.

The resulting surface structure of the obtained stack comprising the Parafil® material, the cured Elastosil® E10 adhesive and the cured polysiloxane layer was consequently also very inhomogeneous and of only poor quality—contrary to surface structure of the stack obtained by the method described in item 1.

1. A method of preparing a molding containing a structured polysiloxane layer as outermost layer, said method comprising
(1) preparing a sheet, film or foil by making use of a molding composition (M),
(2) engraving a structure into at least part of the surface of the sheet, film or foil obtained after step (1) by means of at least one laser,
(3) applying at least one polysiloxane (PS) onto the surface of the sheet, film or foil obtained after step (1), wherein the laser-engraved structure of the sheet, film or foil obtained after step (2) is at least partially covered by the at least one polysiloxane (PS),
(4) curing the at least one polysiloxane (PS) applied in step (3) to obtain a cured polysiloxane (PS) layer at least partially covering the laser-engraved structure of the sheet, film or foil,
(5) adhering at least one fiber containing material onto the surface of the cured polysiloxane (PS) layer obtained after step (4) by making use of at least one adhesive (A1), and
(6) removing the obtained stack comprising the at least one fiber containing material adhered to the cured polysiloxane (PS) layer from the sheet, film or foil prepared by making use of the molding composition (M) and having a laser-engraved structure to obtain the molding containing the cured polysiloxane (PS) layer as structured and outermost layer of the molding, the structure of the cured polysiloxane (PS) layer being the negative of the laser-engraved structure of the sheet, film or foil,
characterized in that the molding composition (M) used in step (1) comprises at least
(m1) 50 to 95 wt.-% of at least one thermoplastic polyester homopolymer, and (m2) 5 to 50 wt.-% of at least one thermoplastic polyester copolymer,
wherein the sum of all constituents (m1), (m2) and optional further constituent(s) present in the molding composition (M) adds up to 100 wt.-%.

2. The method according to claim 1, characterized in that the sheet, film or foil prepared by making use of the molding composition (M) and having a laser-engraved structure re-obtained after removing step (6) is re-usable, in steps (3) to (6) of the method.

3. The method according to claim 1, characterized in that it comprises at least one additional step (7),
(7) adhering at least one metal sheet or plate, onto the surface of the fiber containing material of the molding containing the cured polysiloxane layer as structured and outermost layer of the molding obtained after step (6) by making use of at least one adhesive (A2).

4. The method according to claim 3, characterized in that step (7) is carried out in three sub-steps (7a), (7b) and (7c),
(7a) adhering at least one adhesive (A2), onto the surface of at least one metal sheet or plate, followed by
(7b) applying the molding containing the cured polysiloxane layer as structured and outermost layer of the molding obtained after step (6) with its fiber containing material side onto the adhesive (A2) applied onto the at least one metal sheet or plate in step (7a), followed by
(7c) pressing the stack obtained after step (7b), and curing of the at least one adhesive (A2) to obtain a molding having the following sequence of layers and materials: (i) metal sheet or plate, (ii) cured adhesive (A2), (iii) fiber containing material, (iv) cured adhesive (A1) and (v) cured polysiloxane (PS) layer as structured and outermost layer.

5. The method according to claim 1, characterized in that the at least one polyester copolymer (m2) is a polyester having both aromatic and aliphatic structural units, at least one aliphatic dicarboxylic acid and at least on aromatic acid.

6. The method according to claim 1, characterized in that the engraved structure obtained after step (2) is based on a repeating and/or regularly arranged pattern.

7. The method according to claim 1, characterized in that the least one polyester homopolymer (m1) is selected from the group consisting of polybutylene terephthalate (PBT), polyethylene terephthalate (PET), polytetramethylene terephthalate (PTT), and mixtures thereof.

8. The method according to claim 1, characterized in that the molding composition (M) used in step (1) comprises
(m1) 65 to 90 wt.-%, of the at least one polyester homopolymer,
(m2) 10 to 35 wt.-%, of the at least one polyester copolymer,
(m3) 0 to 40 wt.-% of at least one filler being different from both constituents (m1) and (m2) and
(m4) 0 to 20 wt.-% of at least one further additive being different from both constituents (m1) and (m2) and optional constituent (m3),
wherein the sum of all constituents (m1), (m2) and optional further constituent(s) (m3) and/or (m4) present in the molding composition (M) adds up to 100 wt.-%.

9. The method according to claim 1, characterized in that at least constituents (m1) and (m2) of the molding composition are incorporated therein in form of a polymer blend comprising at least constituents (m1) and (m2).

10. The method according to claim 1, characterized in that step (1) is performed by extruding pellets made from the molding composition (M) into a sheet, film or foil.

11. The method according to claim 1, characterized in that the at least one polysiloxane (PS), is applied in liquid form via a casting process.

12. The method according to claim 1, characterized in that adhering step (5) is performed by making use of at least one polysiloxane adhesive (A1), which is used to adhere the at least one fiber containing material onto the cured polysiloxane (PS) layer.

13. The method according to claim 1, characterized in that it comprises at least one additional step (5a) performed after step (5) and prior to step (6),
(5a) curing the at least one adhesive (A1) used to adhere the at least one fiber containing material onto the cured polysiloxane layer.

14. A molding containing a structured polysiloxane (PS) layer as outermost layer obtainable by the method according to claim 1.

15. A method of using the molding according to claim 14, the method comprising using the molding for producing surface structured coatings.

16. The method according to claim 1, characterized in that it comprises at least one additional step (7),
(7) adhering at least one metal sheet or plate, comprising aluminum or an aluminum alloy, onto the surface of the fiber containing material of the molding containing the cured polysiloxane layer as structured and outermost layer of the molding obtained after step (6) by making use of at least one polysiloxane adhesive (A2).

17. The method according to claim 3, characterized in that step (7) is carried out in three sub-steps (7a), (7b) and (7c),
(7a) adhering at least one polysiloxane adhesive (A2), onto the surface of at least one metal sheet or plate, comprising aluminum or an aluminum alloy, by applying the at least one adhesive (A2) in liquid form via a casting process onto the surface of the at least one metal sheet or plate, followed by
(7b) applying the molding containing the cured polysiloxane layer as structured and outermost layer of the molding obtained after step (6) with its fiber containing material side onto the adhesive (A2) applied onto the at least one metal sheet or plate in step (7a), followed by
(7c) pressing the stack obtained after step (7b), in a static press, and curing of the at least one adhesive (A2) to obtain a molding having the following sequence of layers and materials: (i) metal sheet or plate, (ii) cured adhesive (A2), (iii) fiber containing material, (iv) cured adhesive (A1) and (v) cured polysiloxane (PS) layer as structured and outermost layer.

18. The method according to claim 1, characterized in that the at least one polyester copolymer (m2) is a polyester prepared from at least one aliphatic diol, at least one aliphatic dicarboxylic acid and at least on aromatic acid.

19. The method according to claim 1, characterized in that the least one polyester homopolymer (m1) is polybutylene terephthalate (PBT).

20. The method according to claim 1, characterized in that the molding composition (M) used in step (1) comprises
(m1) 70 to 85 wt.-%, of the at least one polyester homopolymer,
(m2) 15 to 30 wt.-%, of the at least one polyester copolymer,
(m3) 0 to 40 wt.-% of at least one filler being different from both constituents (m1) and (m2) and
(m4) 0 to 20 wt.-% of at least one further additive being different from both constituents (m1) and (m2) and optional constituent (m3),
wherein the sum of all constituents (m1), (m2) and optional further constituent(s) (m3) and/or (m4) present in the molding composition (M) adds up to 100 wt.-%.
